(19) United States
(12) Patent Application Publication
(10) Pub. No.: US 2011/0217136 A1
(43) Pub. Date: Sep. 8, 2011

(54) MACHINE TOOL

(75) Inventors: Alfred Höbel, Lauben (DE); Burkhart Grob, Bad Worishofen (DE)

(73) Assignee: Grob-Werke GmbH & Co., KG, Mindelheim (DE)

(21) Appl. No.: 13/037,782

(22) Filed: Mar. 1, 2011

(30) Foreign Application Priority Data
Mar. 2, 2010 (DE) 10 2010 009 947.3
May 21, 2010 (DE) 10 2010 021 010.2

(51) Int. Cl. B23C 5/26

(52) U.S. Cl. 409/232

(57) ABSTRACT

A machine tool for machining work pieces. It has a machining tool. This is held in a tool mount. For that a tool clamping device is provided. An electric motor serves for generating the clamping power, or at least one means driven by the electric motor acts on a spring arrangement for effecting the release of the machining tool from the tool clamping device.

### CROSS-REFERENCE TO RELATED APPLICATION

This application claims the benefit under 35 USC 119 of German Patent Application DE 10 2010 009947.3 filed Mar. 2, 2010 and German Patent Application DE 10 2010 021 010.2 filed May 21, 2010, the entire disclosure of each of which is incorporated herein by reference.

### BACKGROUND OF THE INVENTION

The invention refers to a machine tool for machining one or more work pieces with a machining tool, wherein the machining tool is held in a tool mount of a tool spindle of the machine tool indirectly or directly by a tool clamping device, and the tool clamping device comprises at least one tool clamping element interacting indirectly or directly with the machining tool.

Machine tools of this kind are sufficiently known in metal processing, in particular in metal-cutting processing. The machining tool is held here by a tool spindle. Usually, a tool spindle serves for driving the machining tool auto-rotary and positioning it on the desired position of the work piece. Therefore, the spindle also has at least one degree of freedom. However, in the following the term “tool spindle” is not restricted to an auto-rotary drive of the machining tool, but restricts the use of the machining tool here in no way. The tool spindle rather provides a one- or multiple-dimensional movement of the machining tool. However, basically, the tool spindle comprises also a stationary tool holding device.

The known machine tools are, as a rule, a high financial investment. It is an object of the present invention to configure the machine tools described in the beginning more efficiently.

The invention achieves an increase of efficiency by two different concepts.

### Short Abstract of the Invention

The problem of the invention is solved, first of all, by a machine tool, as described in the beginning where an electric motor or a spring arrangement is provided for generating the clamping power, and the electric motor or the spring arrangement is in active connection with the tool clamping element, or at least one means driven by the electric motor acts on the spring arrangement for releasing the machining tool out of the tool clamping device.

In known machine tools usually the tool clamping is released hydraulically, or releasing of the machining tool held by a spring arrangement is effected by a hydraulically operated cylinder or the like.

The employment of hydraulic technology has the advantage that with hydraulic components in a rather small space high forces can be generated.

However, it is a disadvantage that the installation of hydraulic lines that have to withstand an appropriate high pressure (several hundred bars), is, for once, expensive and also requires appropriate maintenance. The use of hydraulic technology therefore is rather expensive. The suggestion to use an electric motor as power medium instead of a hydraulic arrangement, deletes the entire hydraulic technology from the area of the tool spindle with considerable advantages for the production of the machine, as well as also for service and maintenance. If necessary, it is also used that by a clever arrangement of the gear an electric motor can generate high forces.

Another suggestion for increasing the efficiency is that the tool spindle has a drive that fixes the machining tool along an active direction via a tension element.

As already described in the beginning, a tool spindle often covers the rotary drive of a machining tool, such as, for example, of a drill or milling cutter. However, the term “tool spindle” does not hint to that solely. Through the suggested machine tool another purpose is added to the metal-cutting machining function of the tool spindle realized by the auto-rotation of the machining tool. By fixing the machining tool on the spindle, for which a drive of the tool spindle serves acting on the machining tool along an active direction via a tension element, the machining tool is locked exactly positioned and stably positioned, respectively, and acts, such as with a turning on a lathe machining, as stationary, non auto-rotary lathe tool that, nevertheless, because of the one or multiple axis movement realized preferably on the tool spindle, can be positioned in the space with reference to the rotary work piece in any way.

By realizing a second machining type in the machine tool, besides the known auto-rotary use of the machining tool, now also the function of a lathe is possible. The consequence of the suggestion is a considerably increase of efficiency.

Favorably it is provided that the machining tool can be fixed axially with reference to the longitudinal axis of the tool spindle. The tool spindle is often configured rotary, and the longitudinal axis of the tool spindle covers at the same time also its rotational axis. The machine tool has the purpose of using a rotary employed tool spindle as holding device for a lathe tool. Additionally, it is favorably also provided to fix the machining tool in the direction of the circumference with respect to the longitudinal axis of the tool spindle. This is realized by an appropriate support of the turning moment, for example by a pin projecting in a boring of the spindle head or a similar arrangement in the pivot or rolling bearing.

Advantageously it is provided that, depending on the position of the tension element preset by the machine control and effected by the drive, the machining tool in the tool spindle serves for an auto-rotary, metal-cutting machining as rotating cutting tool (for example as drill or milling cutter) or a non auto-rotary, metal-cutting machining as lathe tool.

It is provided that the machine control acts in a suitable way on the drive, and thus influences the position of the tension element. It is also provided that the tension element is shifted in active direction to fix thus the machining tool. Thus, the use of the machine tool as lathe is provided, and the machining tool is used in a non auto-rotary, nevertheless, metal-cutting machining as lathe tool. Therefore, it is provided on the machine control to position the tension element via the drive in another way, and in particular not to fix here the machining tool. Thus, an auto-rotary and also metal-cutting machining of the machining tool, for example as drill or milling cutter, is possible.

Preferably it is provided that the tool mount is supported pivoted around a rotational or longitudinal axis in a pivot bearing, and the fixing of the machining tool is carried out by a movement of the tool mount axially with reference to the rotational or longitudinal axis, in particular in the pivot bearing.

The pivot bearing provided for the tool mount has, seen in axial direction, a certain, however slight, elasticity or a free motion. This flexible quality is the result of, the construction of the pivot bearing and the arrangement of the rolling elements in the rolling bearing or pivot bearing. The locking power imprinted by the drive in active direction is here larger than the tension force of the rolling bearing, that is usually rather small, so that the pivot bearing is fixed, and thus there is no turning movement of the machining tool around the rotational axis, either. In this concept fixing of the machining tool is carried out indirectly as the rotational motion of the tool on the tool mount is fixed.

In another alternative or parallel realized concept the machining tool has a supporting device through which the fixed machining tool is supported on the spindle head. In this concept there is no compulsory axial stress of the pivot bearing. The supporting device is formed, for example, by a supporting collar provided on the machining tool or by a supporting plate carrying supporting elements, such as, for example, supporting pins, through which the machining tool can be supported on the spindle head, the front end of the tool spindle. It is therefore possible, that the supporting device can be designed variably, and not only a modification according to the enclosed figure has to be developed. Different embodiments can be realized, for example a protruding spring engaging in a corresponding groove and resulting in a support of the turning moment (fixing in direction of the circumference) as well as also in an axial support.

In a preferred embodiment it is provided that as drive an electric motor or a hydraulic drive or a hydraulic motor is provided. In connection with the machine tool according to the invention, that can be used in two different ways of machining, the invention allows the alternative use of an electric motor or a hydraulic drive as drive. As in particular an axial pull-back movement of the machining tool relatively to the tool spindle is decisive, such a pull-back movement or active movement, can, for example, also be realized by a hydraulically impinged piston in an arrangement such as a working cylinder. The rotary motion of the rotor of an electric motor is here translated in an axial motion according to the invention by a ball screw spindle.

The efficiency of the machine tool is increased, first of all, by using instead of expensive hydraulic components one or more electric motor(s) as drive(s), in particular as indirect or direct clamping or rotary drive(s).

It is seen here as favorable if an electric motor, in particular a servo motor is used as drive. This electric motor or servo motor can be designed in particular as synchronous, asynchronous or direct current motor. An advantage when servo motors are employed, is their compact construction, and the possibility for an operation in a closed control circuit. The operation can be here moment controlled, speed controlled or position controlled.

It is seen as advantageous development if the drive is carried out via a sensorless synchronous or asynchronous motor. In particular, a permanent magnet excited synchronous motor (PMSM) is preferred here. The suggestion comprises here in the same way the arrangement of the permanent magnet (s) as buried magnet (s) or as surface magnet (s) on the rotor, wherein the use of buried magnet (s) in the rotor is seen as particularly advantageous as mechanic stress occur in the bundle of laminations of the rotor and not on the surface. Additionally the losses in the permanent magnet are lower.

The use of the permanent magnets on or in the rotor makes the excitation winding, otherwise present with synchronous machines, unnecessary.

It is seen as an advantage of the use of sensorless motors, in particular of synchronous motors, that here the additional arrangement of transmitters and sensors for the rotor position definition can be dropped, and the constructional size is reduced accordingly. In the machine tools according to the invention or in the tool or tool clamping or lathe devices provided in them, the constructive space for the single components is small to be able to realize a construction of the entire machine center as compact as possible. Besides an increase of the efficiency of the dynamic of conventional machine tools, through the use of sensorless motors the constructive space or the requirements of constructive space with reference to the drive can be optimized.

In an embodiment of the machine tool seen as preferred, a sensorless rotor position definition, in particular a sensorless standstill position recognition is provided that can be realized in particular via the sensorless synchronous motor. Thus, in a sensorless synchronous motor, for example, the position of the rotor can be estimated by means of an anisotropy of the resulting inductance in the used stator coils of the stator. During operation of the synchronous motor, depending on the rotor position, in the stator coils different resulting inductances can be measured through which the position of the rotor can be estimated. In this connection it is seen as advantageous, if the rotor position definition or the standstill position recognition can be carried out software- or NC-controlled. A suitable integration in the machine control, for example a machine control comprising a micro controller, can be realized in a simple manner.

A preferred possibility for defining the rotor position or the standstill position provides, for example, that measuring signals are superimposed the selecting signal for connecting the stator currents for the stator coils in such a way that additionally to the driving magnetic field an alternating magnetic field is generated, wherein the current flows caused by the multiple signals depend on the rotor position-depending, resulting inductance of the synchronous motor. The resulting inductance of the synchronous motor depends on the position of the rotor. The process for sensorless rotor position definition is based here on the detection of the magnetic anisotropy of series and shunt inductance of the motor. If a fast alternating voltage is connected to the motor the voltage in the pillar lane drops almost exclusively on the rotor position depending inductance. The excited current is thus modulated by the rotor position, and can be evaluated accordingly. The strength of the signal is proportional to the difference of series and shunt inductance.

The input and output signals are processed by a control or measuring software or the NC-control to define through that the rotor position or the standstill position. This again defines the tool use position or the work piece machining position or the position of the clamping element or clamping device for the work piece driven by such an electric motor. If necessary, in the machine control a separate switching circuit or a micro controller programmed for it is provided for the evaluation of the rotor position.

The use of synchronous motors has other advantages besides the reduction of the constructive space required for the drive. Thus the expenses for installation are reduced altogether as sensor line, sensor and sensor interface are dropped. The synchronous motors allow a higher dynamic and a slip-free motion. Besides the reduced requirement of space, they also have a lower weight, however, they possess a high efficiency and availability. The position definition can be integrated in a simple manner in the machine control of the machine tool according to the invention, resetting or retrofitting of existing machines is possible.

Another considerable advantage of the use of an electric motor compared with the use of other types of drives, such as for example a hydraulic drive, for once, is the fact that monitoring the performance of the electric motor can be realized rather simply by a suitable monitoring of the current. An electric motor can also be monitored more accurately with reference to its rotor position than a hydraulic drive, and therefore it is possible by an appropriately intelligently controlled process of the drive furnished as electric motor to reduce the exchange times of a tool exchange as by the position of the element, for example the clamping elements, driven by the drive, the state of the tool is defined exactly, that is, for example, clamped, held, but not yet clamped or just unclamped or released to exchange the tool. Here are considerable advantages of the use of an electric motor for this purpose compared with the hydraulic drives known from the state of the art.

### BRIEF DESCRIPTION OF THE DIFFERENT VIEWS OF THE DRAWINGS

In the drawing the invention is shown schematically in particular in an embodiment. In the figures:

FIGS. 1, 2a, 3 each in a side view the tool spindle of a machine tool according to the invention.

FIG. 2b in a top view the front side of the tool spindle of the machine tool of the invention according to FIG. 2a.

In the figures identical or corresponding elements each are indicated by the same reference numbers, and therefore are, if not useful, not described anew.

### DETAILED DESCRIPTION OF THE PREFERRED EMBODIMENT

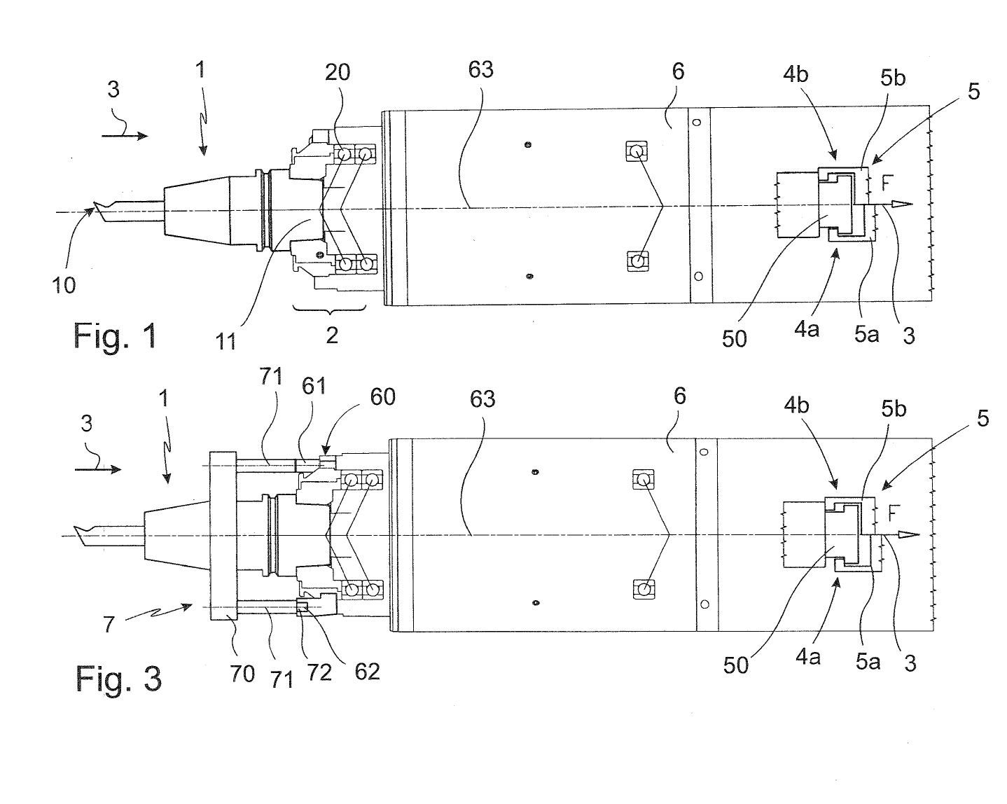

In FIGS. 1, 2a and 3 in the right area in the respective drawing each time two different positions are shown and indicated by the letters a and b. One embodiment of the machine tool has the purpose of realizing two fields of use or ways of use with the machine tool described here. For this, in the tool spindle 6, in particular on the side opposite the machining tool 1 (in FIGS. 1, 2a, 3 on the right hand side), a separate drive is provided the adjusting element of which is indicated by reference number 5 that synonymously can also be used for the drive. The figure shows schematically the two different positions of the adjustment element 5. In the top section (with reference to the center axis 63) the standard position 4b is shown; in the bottom section the fixed position 4a of the machining tool 1 is shown. The drive 5 or its adjusting element 5a is also shown in two different positions 5a, 5b. In the position 4a the adjustment element 5a, designed c-shaped in section, grips behind the tension element 50 designed on its end like a hammer head. The tension element 50 is connected with built-in parts not shown in detail that finally operate a clamping element of the clamping device and thus hold the machining tool 1 in the tool mount 2. The pull-back motion of the tension element 50 to the right is indicated by active direction 3. The active direction 3 effects finally also that the machining tool 1 is drawn in the front area of the spindle 6 or to the right. The drive shown schematically in the drawing and indicated by reference number 5 can have different embodiments. Thus, the drive 5 can be designed as electric motor or as hydraulic motor or drive. The electric motor can be built in as synchronous, asynchronous or direct current motor, wherein the use as sensorless synchronous or asynchronous motor has decisive advantages with respect to the rotor position or standstill position recognition as well as with reference to the constructive dimensions.

In the embodiments shown in FIG. 1 the machining tool 1 is put back by the movement of the drive 5 in such a way that its tool mount 2 exercises an axial force on the pivot or rolling bearing 20. The tool base 11 is here inserted in the tool mount 2, the elements of the clamping device are shown only schematically, the tool mount 2 is pivoted on bearings around the rotational/longitudinal axis 63 in the rolling bearing or pivot bearing 20. Shifted to the right by the force F resulting from the drive 5 in active direction 3, a corresponding axial force is created in the pivot bearing 20 that leads to a compensation of the free rotary motion, and a fixing of the pivot bearing 20 or the rotational motion. However, if the rotational motion of the pivot bearing 20 is removed, the machining tool 1 is not able anymore to rotate, and is thus also fixed.

In the example shown in FIG. 1 the machining tool 1 is fixed indirectly via the fixing of the pivot bearing 20.

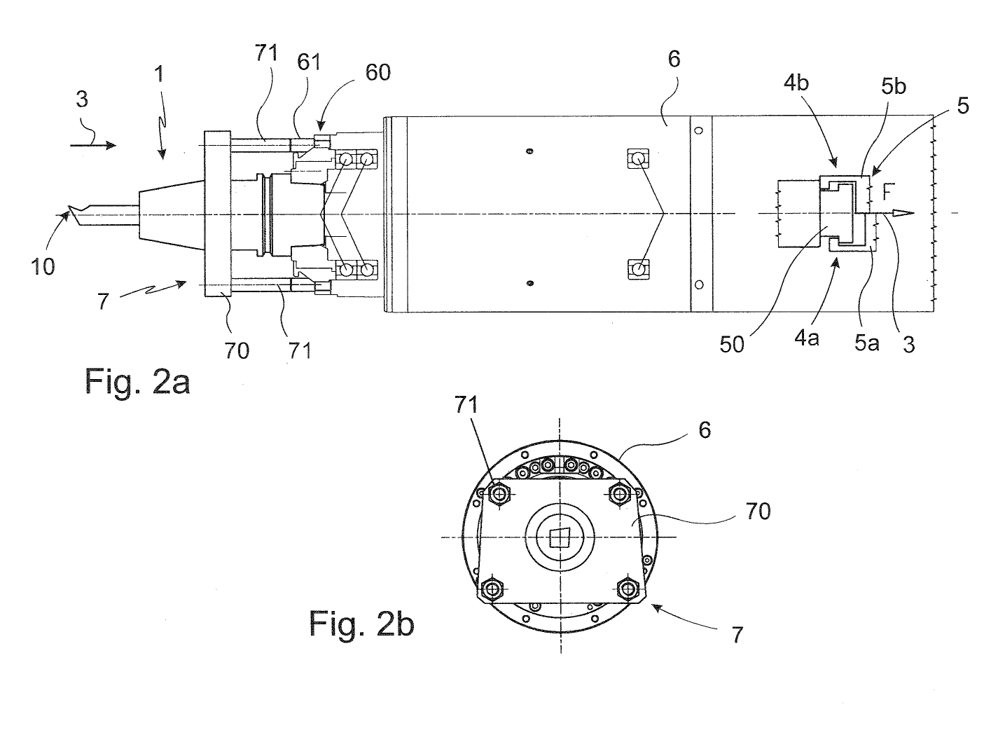

FIG. 2a, 2b or 3, however, show another modification where the machining tool 1 itself is fixed, that is directly or immediately by the position of the tension element 50, caused by the drive 5.

The machining tool 1 carries here a supporting device 7 formed by a supporting plate or supporting collar 70 slid on the machining tool. The dimension of this supporting plate 70 is larger than the diameter of the tool shank of the machining tool 1. On the side of the supporting plate 70 opposite the tool tip 10 the supporting device 7 has several supporting elements 71, for example supporting pins 71 that are supported next to the tool mount 2 on the spindle head 60 on a supporting area 61 or supporting ring 61 in axial direction.

The machining tool 1 is fixed here in the direction of the circumference (with respect to the rotational axis 63) through friction of the supporting elements 71 on the supporting area 61. To reach a better turning moment support, in FIG. 3 an improvement is suggested according to the invention. A turning moment support 72 is realized on the lower supporting pin 71. This is formed by positive locking projecting of the end of the supporting pin 71 opposite the supporting plate 70 in a boring 62 of the supporting area 61.

Although the invention has been described by means of exact examples that are illustrated in the most extensive detail, it is pointed out that this serves only for illustration and that the invention is not necessarily restricted to it, as alternative embodiments and methods become clear for experts in view of the disclosure. Accordingly, changes are considered that can be made without deviating from the contents of the described invention.

1. Machine tool for the machining of one or more work pieces with a machining tool, wherein the machining tool is held indirectly or directly in a tool receiver of a tool spindle of the machine tool by a tool clamping device, and the tool clamping device comprises at least one tool clamping element interacting indirectly or directly with the machining tool, characterized in that an electric motor or a spring arrangement is provided for generating the clamping force, and the electric motor or the spring arrangement is in active connection with the tool clamping element, or at least one means driven by the electric motor acts on the spring arrangement for releasing the machining tool from the tool clamping device.

2. Machine tool according to claim 1, characterized in that the machine tool has a drive with an active direction and a tension element, wherein the tool spindle has the drive with the active direction, and the drive defines the machining tool along the active direction by the tension element.

3. Machine tool according to claim 1, characterized in that the machine tool has a longitudinal axis, wherein the longitudinal axis is provided in the tool spindle, wherein the machining tool can be defined axially with respect to the longitudinal axis of the tool spindle.

4. Machine tool according to claim 1, characterized in that the machine tool has a longitudinal axis and a circumferential direction, wherein the longitudinal axis is provided in the tool spindle, and the machining tool can be defined in circumferential direction with respect to the longitudinal axis of the tool spindle.

5. Machine tool according to claim 1, characterized in that the machine tool has a drive, a tension element, a rotating cutting tool, a lathe tool and a position of the tension element, wherein depending on the position of the tension element preset by the machine control and effected by the drive the machining tool in the tool spindle serves for an auto-rotary, metal-cutting machining as rotating cutting tool (e.g. drill or milling cutter) or for a non auto-rotary, metal-cutting machining as lathe tool.

6. Machine tool according to claim 1, characterized in that the machining tool has a pivot bearing, a longitudinal and a rotational axis and an axial motion of the tool receiver, wherein the tool receiver is pivoted around the rotational or longitudinal axis in the pivot bearing, and the defining of the machining tool is carried by the motion of the tool receiver axially with reference to the longitudinal or rotational axis, in particular in the pivot bearing.

7. Machine tool according to claim 1, characterized in that the machine tool has a drive, an electric motor, a hydraulic drive or a hydraulic motor, wherein the electric motor or the hydraulic drive or the hydraulic motor is provided as drive.

8. Machine tool according to claim 1, characterized in that the machine tool has a drive, an electric motor, a servo motor, a synchronous, asynchronous or direct current motor, wherein the electric motor, the servo motor, the synchronous, asynchronous or direct current motor is provided as drive.

9. Machine tool according to claim 1, characterized in that the machine tool has a drive, an electric motor, a sensorless synchronous or asynchronous motor, wherein the sensorless synchronous or asynchronous motor is provided as drive.

10. Machine tool according to claim 1, characterized in that the machine tool has a drive and permanent magnet excited synchronous motor, wherein the drive is designed as permanent excited synchronous motor.

11. Machine tool according to claim 1, characterized in that the machine tool has a drive, an electric motor, a servo motor, a synchronous, asynchronous or direct current motor, a sensorless synchronous or asynchronous motor, a permanent magnet excited synchronous motor and a sensorless rotor position definition and a sensorless standstill position recognition, wherein the sensorless rotor position definition or the sensorless standstill position recognition is provided in the electric motor, the servo motor, the synchronous, asynchronous or direct current motor, the sensorless synchronous or the asynchronous motor.

12. Machine tool according to claim 1, characterized in that the machine tool has a drive, an electric motor, a servo motor, a synchronous, asynchronous or direct current motor, a sensorless synchronous or asynchronous motor, a permanent magnet excited synchronous motor, a sensorless rotor position definition, a sensorless standstill position recognition and a software or NC control, wherein the rotor position definition or the standstill position recognition can effected software—of NC-controlled.

13. Machine tool according to claim 1, characterized in that the machine tool has a drive with an active direction and a release direction not corresponding with the active direction or in opposite direction of the active direction, wherein the drive serves for releasing the machining tool from the tool clamping device in the release direction not corresponding with the active direction or in opposite direction of the active direction.

14. Machine tool according to claim 1, characterized in that the machine tool has a supporting device and a spindle head, wherein the machining tool carries the supporting device by which the fixed machining tool is supported on the spindle head.

15. Machine tool according to claim 1, characterized in that the machine tool has a tool tip, a tool base and an active direction, wherein the active direction is orientated from the tool tip to the tool base held in the tool mount.
